(19) United States
(12) Patent Application Publication
(10) Pub. No.: US 2006/0000315 A1
(43) Pub. Date: Jan. 5, 2006

(54) Handheld tool with barbed end for repacking encapsulated valve actuators

(75) Inventor: Scott R. Patterson, Fort Collins, CO (US)

Correspondence Address: JEAN M. MACHELEDT, 501 SKYSAIL LANE, SUITE B100, FORT COLLINS, CO, 80525-3133, US

(73) Assignee: Colorado State University Research Foundation

(21) Appl. No.: 10/884,352

(22) Filed: Jul. 2, 2004

(51) Int. Cl. B25B 33/00

(52) U.S. Cl. 81/8.1

(57) ABSTRACT

A tool having: (a) an inner-surface defining a hollow extending within the tool and sized to accept the stem at an end-port of the hollow and to permit a sliding of the hollow along the stem; (b) an integral handle having a grip surface around at least a portion of the hollow; and (c) at one end of the tool and located a distance, d_{N}, from the handle, is an integral barbed-end comprising a plurality of barbs, each barb having a length of sharp edge. The length of sharp edge of a barb is disposed between a tapered surface and a blade surface oriented generally orthogonal to the inner-surface of the hollow such that the blade surface will contact the flexible packing for removal. The tool can also have an integral second barbed-end. Each of the barbs of a barbed-end can be curve-tooth shaped; or a barbed-end can have a plurality of barbs arranged such that each of the tapered surfaces is concentrically oriented along an axis of the inner-surface. Also, a method having the steps: (a) inserting the stem into an end-port of a hollow extending within the tool and sliding an inner-surface defining the hollow, along the stem; (b) upon penetrating the flexible packing with at least a portion of a length of sharp edge of a first barb of a barbed-end of the tool, applying a tangential-twisting force to an integral handle having a grip surface, slidably-revolving the hollow around the stem, to further penetrate the flexible packing such that a blade surface of the first barb contacts the flexible packing; and (c) applying an axial force to the handle in a direction opposite to an initial force used during the step of inserting, and pulling the flexible packing in contact with the first barb in the opposite direction along the stem.

### BACKGROUND OF THE INVENTION

In general, the present invention relates to tools employed for the removal of packing, e.g., ring packs, split-ring packing, V-ring packing, flexible spacers, and such, that is in place around a conventional cylindrical stem (typically made of metal/metal alloy) inside a valve actuator assembly. By way of example only, pneumatic valve actuators that have an encapsulated spring mechanism are used to convert air pressure into motion. Valve assemblies of the type containing a valve stem with which the tool of the invention may be used, include those manufactured and/or distributed by: Johnson Controls, Inc., Siemens Building Technologies, Inc., Honeywell Corporation, among others.

Typically, the removal of such flexible packing—which is made of an elastomeric material—is done when the packing no longer is performing its function to provide a hermetic seal around the stem to a sufficient degree within an encapsulated/encased type valve actuator assembly. It is not uncommon for this packing to breakdown one or more times over the useful lifetime of a valve assembly. Conventional practice is to replace the whole valve actuator assembly. This, however, is extremely costly as the valve assemblies are quite expensive. Valve assemblies of the type that utilize such packing around a stem, are found in a wide variety of complex pneumatic and/or hydraulic systems: HVAC (Heating Ventilation Air-Conditioning) systems found in buildings (commercial and residential), manufacturing equipment, jet airliners, vehicles that run on tracks (subway, light-rail trains, etc.), trucks and other large vehicles. As one can imagine, where hundreds of valve actuators are in-use, replacing packing utilizing the effective tool of the invention, rather than replacing expensive whole valve assemblies, can result in substantial decrease in overall system maintenance costs. Furthermore, waste associated with disposing of whole valve assemblies containing functionally operational components, but simply not functioning as a unit due to a leaky packing, can be by-and-large eliminated. The handheld tool of the invention permits an environmentally useful mechanism with opportunity for maintenance cost reduction: A winning combination.

There are a wide variety of valve actuator assembly configurations that incorporate packing installed around the stem (a smooth cylindrical rod used as a support around which components are built to produce the desired actuator movement) so as to provide a hermetic seal, preventing fluid leaks (whether air or a liquid). This packing is often referred to as ring packs, spacers, and so on, and is typically made of an elastomeric or other such flexible, pliable material that, under pressure, can provide a good seal. Conventional techniques used to remove and ‘repack’ the valve actuator assembly—such as the small, cylindrical ˜2½ inch long brittle plastic device depicted in the drawing labeled “FIG. 5: Bullet Installation Method” on p. 2 of Reference D (3 pgs.) fully incorporated herein by reference, and the sharp hooked-end pick-tool, made of metal, typically recommended by valve manufacturers to dig out the old packing—have several drawbacks. The small brittle plastic device, while it has a few ridges at a “Removal End” as labeled in FIG. 5 Reference D (p. 2), it is extremely difficult to remove packing from around a valve stem without damaging the small brittle device. The sharp metal hooked-end pick-tool provided with most valve repacking kits is very dangerous to use: The hooked-end is used to dig out the packing from around the valve stem and pull it off the stem. Doing so often damages the stem with scratches. Worse yet, is the painful injury often resulting to the technician while pulling back with the pick-tool. For reference, see the pages labeled Reference D which include drawings taken from a Valve Repacking Kit product brochure distributed by Johnson Controls, Inc. for use to repack Johnson's VT Series Valves, and a cross-sectional drawing of components of a valve assembly, labeled FIG. 4, taken from a brochure distributed by Siemens Building Technologies, Inc.

One can readily appreciate the many fundamental distinguishing features of the new packing removal tool and associated method for removing flexible packing in place around the stem of a valve assembly using a handheld tool according to the invention, from conventional devices/mechanisms used to remove and/or repack valve actuator assemblies having a stem about which the packing is placed.

### SUMMARY OF THE INVENTION

It is a primary object of this invention to provide a handheld tool, and associated technique, for removing flexible packing in place around the stem of a valve assembly.

The tool has: (a) an inner-surface defining a hollow extending within the tool and sized to accept the stem at an end-port of the hollow and to permit a sliding of the hollow along the stem; (b) an integral handle having a grip surface around at least a portion of the hollow; and (c) at one end of the tool and located a distance, d_{N}, from the handle, is an integral barbed-end comprising a plurality of barbs, each barb having a length of sharp edge. The length of sharp edge of a barb is preferably disposed between a tapered surface and a blade surface oriented generally orthogonal to the inner-surface of the hollow such that the blade surface will contact the flexible packing for the removing thereof. The tool is preferably elongated in shape. The integral handle may surround the hollow with the grip surface having a textured knurl. Upon the sliding of the hollow along the stem so that the lengths of sharp edge penetrate the flexible packing, a first and second of the blade surfaces contact the flexible packing.

As one will appreciate, in a further distinguishing characterization of the invention the tool can also have, located a second distance, d₂, from the handle, an integral second barbed-end comprising a plurality of second barbs; each of these second barbs can, likewise, have a length of sharp edge.

In one aspect of the invention, each of the plurality of barbs of one of the barbed-ends is curve-tooth shaped and further comprises an outer curvilinear surface. In this case, along the distance from the handle to the one end, the tool preferably has a cylindrical outer surface, whereby the curve-tooth shaped barbs are arranged around the one end with their outer curvilinear surfaces flush with the cylindrical outer surface. The plurality of barbs are preferably arranged such that each of the tapered surfaces taper inwardly toward the inner-surface, and a base of each curve-tooth shaped barb is generally equidistant around the cylindrical outer surface of the one end from the base of adjacent curve-tooth shaped barbs. The blade surface of one of the plurality of barbs may be oriented generally facing the tapered surface of an adjacent of the plurality of barbs, with an angle between the blade surface of each of the plurality of barbs and an axis of the inner-surface being between 30 degrees and 60 degrees (with an angle of approx. 45 degrees being quite suitable). Preferably, the inner-surface is cylindrically shaped permitting the hollow to slidably-revolve around the stem upon application of a tangential-twisting force applied to the handle. Furthermore, each of the blade surfaces can be triangularly shaped having at least one curvilinear side.

In another aspect of the invention, the plurality of barbs of one of the barbed-ends are arranged such that each of the tapered surfaces is concentrically oriented along an axis of the inner-surface, the length of sharp edge of each barb being respectively concentrically oriented along the axis. In this case, each of the blade surfaces is generally ring-shaped and oriented radially orthogonal to the inner-surface. An angle between the blade surface of one of the plurality of barbs and the tapered surface of an adjacent of the plurality of barbs, is preferably between 30 degrees and 60 degrees (with an angle of approx. 45 degrees being quite suitable). Preferably, the inner-surface is cylindrically shaped permitting the hollow to slidably-revolve around the stem upon application of a tangential-twisting force applied to the handle.

In another characterization, the invention is a method for removing flexible packing in place around the stem of a valve assembly using a handheld tool. The method comprises the steps of: (a) inserting the stem into an end-port of a hollow extending within the tool and sliding an inner-surface defining the hollow, along the stem; (b) upon penetrating the flexible packing with at least a portion of a length of sharp edge of a first of a plurality of barbs of an integral barbed-end of the tool, applying a tangential-twisting force to an integral handle having a grip surface around at least a portion of the hollow, slidably-revolving the hollow around the stem, to further penetrate the flexible packing such that a blade surface of the first barb contacts the flexible packing; and (c) applying an axial force to the integral handle in a direction opposite to an initial force used during the step of inserting, and pulling the flexible packing in contact with the first barb in the opposite direction along the stem for the removing. Further distinguishable features of the method characterization include: (a) the step of applying the tangential-twisting force further results in penetrating the flexible packing with each of a respective length of sharp edge of a second, third, and fourth of the barbs, such that a respective blade surface of each of the second, third, and fourth barbs also contact the flexible packing; and (b) the step of pulling the flexible packing further comprises pulling flexible packing in contact with each of the respective blade surfaces.

In a first aspect of the method of the invention, each of the barbs is curve-tooth shaped and further comprises an outer curvilinear surface, the plurality of curve-tooth shaped barbs being arranged around the barbed-end such that the outer curvilinear surfaces are flush with a cylindrical outer surface of the barbed-end. In this case, the step of penetrating the flexible packing with each of a respective length of sharp edge of the barbs further comprises a generally simultaneous penetration of the respective blade surfaces into the flexible packing.

In a second aspect of the method of the invention, the step of applying the tangential-twisting force further results in penetrating the flexible packing with each of a respective length of sharp edge of a second, third, and fourth of the barbs. In this case, the plurality of barbs are arranged such that each of the tapered surfaces is concentrically oriented along an axis of the inner-surface, the length of sharp edge of each barb being respectively concentrically oriented along the axis; such that, the step of penetrating the flexible packing with each of a respective length of sharp edge of the barbs further comprises a sequential penetration of the respective blade surfaces into the flexible packing.

As one will readily appreciate in connection with the instant technical disclosure, the applicant has identified unique handheld tool structures, and associated techniques, targeted for removing flexible packing in place around the stem of a valve assembly using a handheld tool. The tools can be machined, cut, cast, molded, or otherwise fabricated of a material that has sufficient structural integrity to hold the lengths of sharp edge of the barbs. While, preferably, the tool is made of a metal, alloy, or a glass-filed nylon, a multitude of materials are contemplated for use according to the invention in connection with fabricating the tool—including alloys, metals, reinforced resins, and other rigid plastics (thermoplastic and thermosetting structures).

Certain of the several unique features, and further unique combinations of features, as supported and contemplated in the instant technical disclosure may provide a variety of advantages; among these include: (a) Design flexibility and versatility—basic structure is adaptable for use to remove packing from within valve-type assemblies of a variety of shapes and sizes; (b) reduction of waste associated with disposing of a whole valve-type assembly having degraded/defective packing, where components of the assembly are still functioning, which may result in maintenance/replacement cost savings, over time; and (c) installation is handy employing the new tool and technique—conventional packing removal devices currently used for removing packing from around the stems of encapsulated valve assemblies are often ineffective and/or dangerous to use. Other advantages of providing the new handheld tool structures and associated method of removing, will be appreciated by perusing the instant technical discussion, including the drawings, claims, and abstract, in light of drawbacks to existing devices that have been identified, or may be uncovered.

### BRIEF DESCRIPTION OF THE DRAWINGS

For purposes of illustrating the innovative nature plus the flexibility of design and versatility of the preferred tool structures supported and disclosed hereby, the invention will be better appreciated by reviewing the accompanying drawings (in which like numerals, as included, designate like parts). The drawings have been included to communicate and demonstrate, in pictorial fashion, the unique features of the innovative structures of the invention by way of example, only, and are in no way intended to unduly limit the disclosure hereof.

FIGS. 1A-1C depict tool structure of the invention 10 having, at one end, an integral barbed-end 14. FIG. 1A is an isometric view of the tool 10, FIG. 1B a side plan view of barbed-end 14, and FIG. 1C is a plan view taken along 1C-1C of FIG. 1B of barb 17.

FIGS. 2A-2B depict an alternative tool 20, of an elongated shape, having a barbed-end 24 and another barbed-end 22. FIG. 2A is an isometric view of the tool 20, and FIG. 1B an end plan view of barbed-end 24

FIG. 3 is another isometric view of tool 20 of the invention.

FIG. 4 is a sectional view of tool 10 taken at the centerline along the axis of the hollow labeled 13.

FIG. 5A is a sectional view of tool 20 taken at the centerline along the axis of the hollow labeled 23b-23c.

FIG. 5B is an enlargement of barbed-end 24 of tool 20.

FIG. 5C is an enlargement of barbed-end 22 of tool 20.

FIGS. 6A-6B depict conventional valve assemblies 61a, 62a with which barbed-ends 14, 22, respectively, are operationally engaged to remove packing 65a, 65b, respectively.

### DETAILED DESCRIPTION OF EMBODIMENTS DEPICTED IN DRAWINGS

In connection with discussing the unique features depicted in the figures, occasional reference will be made back-and-forth to other of the figures which detail core, as well as further unique and distinguishing features of the tool and associated method for removing flexible packing in place around the stem of a valve assembly using a handheld tool according to the invention—demonstrating the flexibility of design of the invention.

While, preferably, the tool is made of a metal, alloy, or a glass-filed nylon, a multitude of materials are contemplated for use according to the invention in connection with fabricating the tool—including alloys, metals, reinforced resins, and other rigid plastics (thermoplastic and thermosetting structures). By way of background, only, for general reference: Thermoplastics include those plastics having polymer chains more-easily broken with heat; vs. the polymer chains in thermosetting plastics typically do not separate completely with heat. The term “nylon” refers, generically, to polymer materials having long-chain polymeric amide molecules in which recurring amide groups are part of the main polymer chain. The term ‘alloy’ refers to any combination of elements typically having metallic properties. Resins are any of a class of solid or semisolid organic products of natural or synthetic origin with no definite melting point, generally of high molecular weight—typically composed of a polymer. In any case and as one can appreciate, many well known manufacturing techniques exist (such as extruding/extrusion, casting, pulling, many types of molding, machining, cutting, and so on) that may be suitable for use in fabricating the handheld tool of the invention, depending upon whether a metal or rigid plastic, such as a glass-filed nylon is selected.

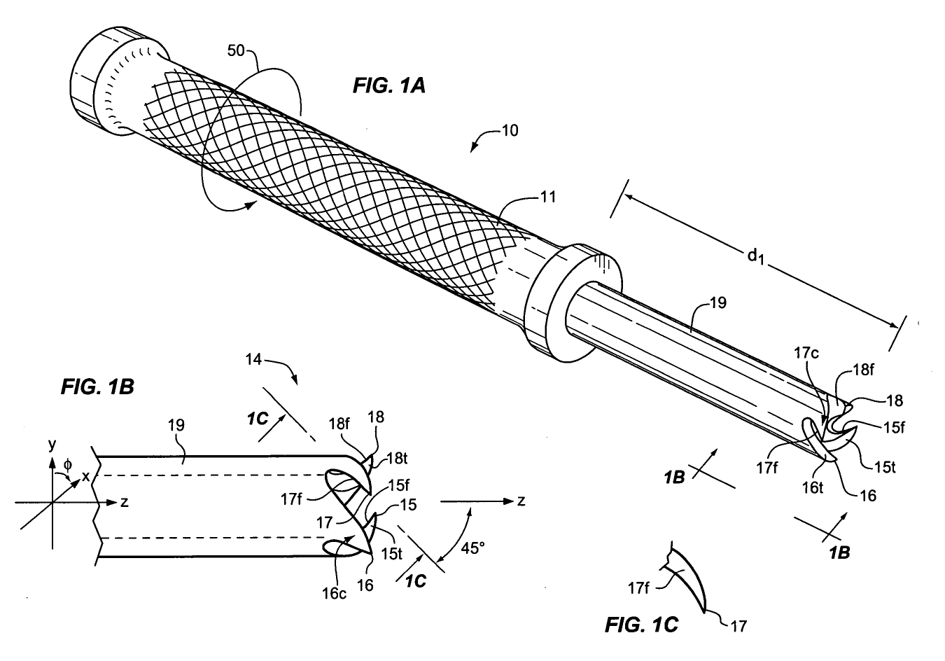

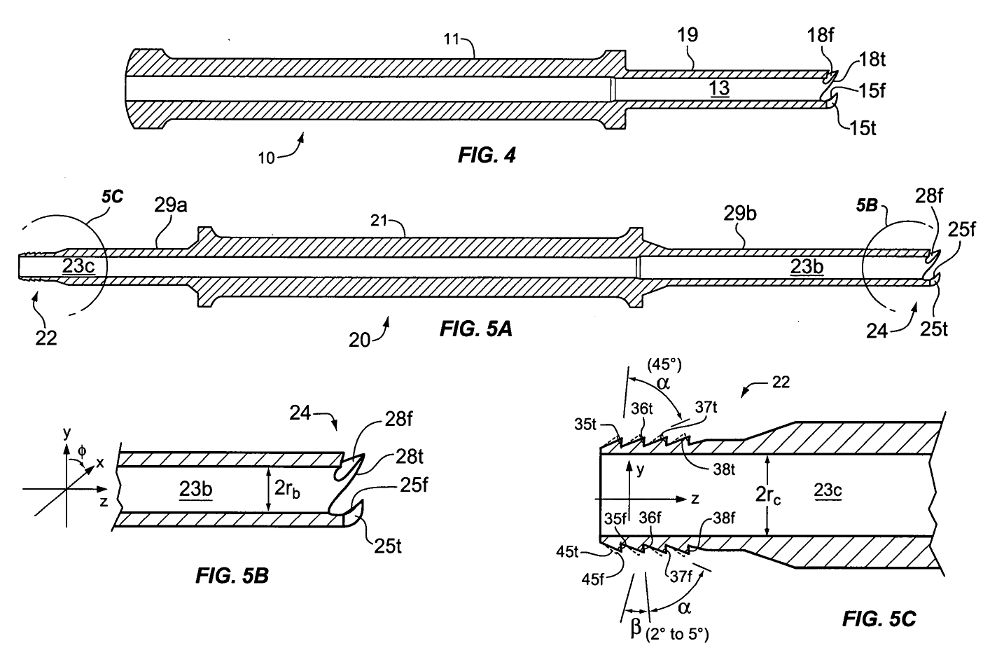

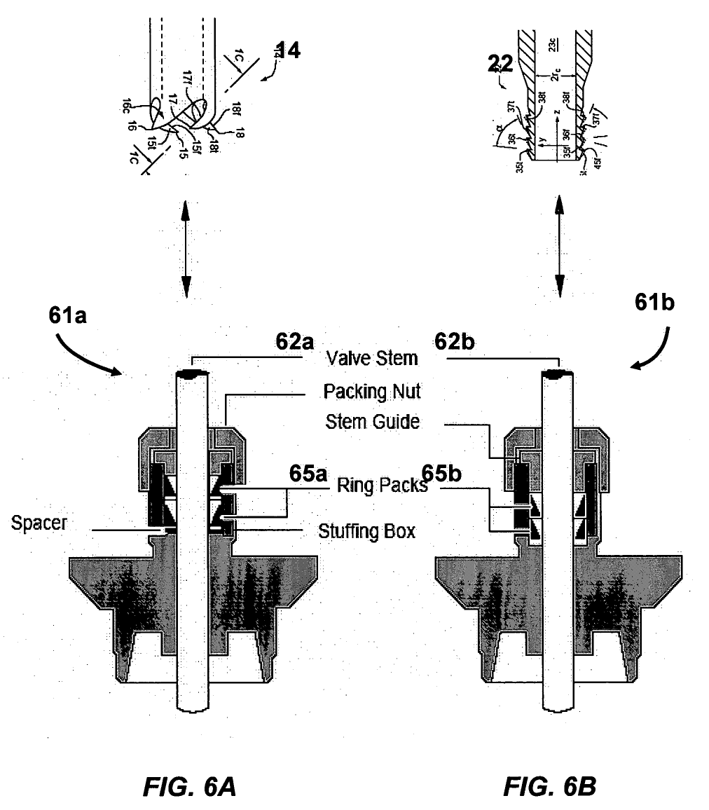

In FIGS. 1A-1C, barbed-end 14 of tool 10 has four barbs 15-18, each having a length of sharp edge (not labeled) disposed between a respective tapered surface 15t-18t and a blade surface 15f-18f. An integral handle 11, here, surrounds the hollow with a grip surface having a textured knurl. Integral barbed-end 14 (labeled in FIG. 1B, but not in FIG. 1A) is located a distance, d₁, from handle 11. Preferably, an inner-surface of the hollow (unlabeled in FIGS. 1A-1C, but labeled at 13 in the cross-sectional of tool 10 in FIG. 4) is cylindrically shaped permitting the hollow to slidably-revolve around the stem upon application of a tangential-twisting force applied to the handle 11 along direction 50, for example. The inner-surface defining the hollow (see FIG. 4 at 13) preferably extends within tool 10 at least along distance, d₁, to the barbed-end and is sized to accept the stem (examples depicted in FIGS. 6A-6B) at an end-port of the hollow and to permit a sliding of the hollow along the stem. Reference D (3 pgs.) as mentioned above, provides further detail of the stem and packing features of conventional valve assemblies. In FIG. 4, one can see that hollow 13 extends the full length of tool 10, permitting use over a stem (e.g., 62a, 62b, FIGS. 6A-6B) of equal or longer length than the tool length. Turning also to FIGS. 6A-6B, in the event the tool is shorter than the stem (e.g., 62a, 62b), the stem will exit the hollow 13 upon moving the tool along the stem a sufficient distance to penetrate the flexible packing (e.g., 65a, 65b) with at least a portion of a length of sharp edge of one or more barbs.

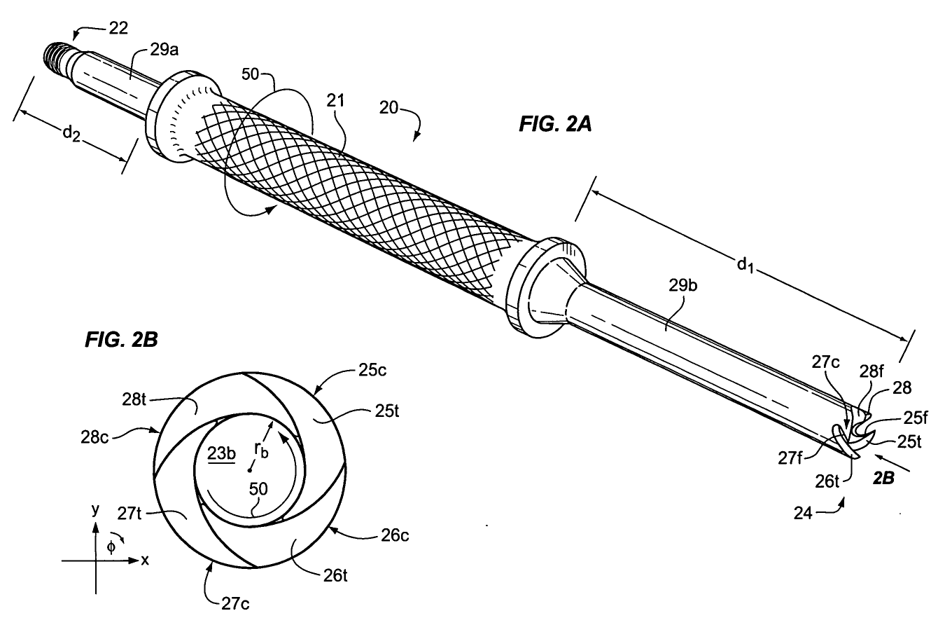

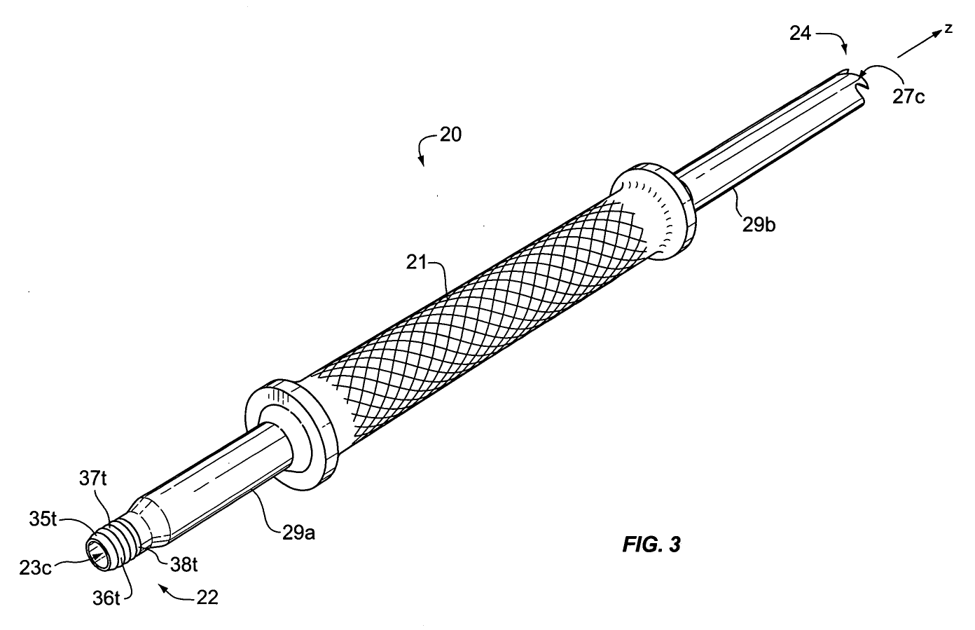

Each blade surface 15f-18f is oriented generally orthogonal to the inner-surface of the hollow. FIG. 1C is representative of blade surfaces 15f-18f: It is a plan view taken along 1C-1C of FIG. 1B of barb 17. Blade surface 17f, by way of example only, is triangularly shaped having at least one curvilinear side. By way of reference only, the term ‘blade’ typically refers to a flat sharp-edged cutting part of a tool used for lifting and moving material. Upon the sliding of the hollow along a stem of a valve assembly so that the lengths of sharp edge penetrate the flexible packing, one can appreciate that blade surfaces 15f-18f will contact the flexible packing. In this aspect of the invention (shown in FIGS. 1A-1C and FIG. 4 as well as in FIGS. 2A-2C, 3, 5A-5B at 24), each of the barbs 15-18 is curve-tooth shaped and has an outer curvilinear surface, such as that labeled for barb 17 at 17c (FIG. 1A) and that labeled for barb 16 at 16c (FIG. 1B). Along distance, d₁, to barbed-end 14, tool 10 has a cylindrical outer surface 19. The curve-tooth shaped barbs are arranged around the end with respective outer curvilinear surfaces (e.g., 16c, 17c) flush with cylindrical outer surface 19. Likewise, as can be appreciated in FIGS. 2A-2B and 3, along distance, d₁, to barbed-end 24, tool 20 has a cylindrical outer surface labeled 29b. The curve-tooth shaped barbs 25-28 are arranged with respective outer curvilinear surfaces (25c-28c) flush with cylindrical outer surface 29b.

As depicted in FIGS. 1A-1C at 14 as well as in FIGS. 2A-2C, 3, 5A-5B at 24, barbs 15-18, 25-28 are preferably arranged such that respective tapered surfaces 15t-18t, 25t-28t taper inwardly toward the hollow's inner-surface, and a base of each curve-tooth shaped barb is generally equidistant around the cylindrical outer surface, respectively 19, 29b. A symmetrical configuration of barbs around the tool may be obtained whether more or fewer than four barbs—as shown by way of example only—are fabricated into a barbed-end 14, 24 of the one end from the base of adjacent curve-tooth shaped barbs. The blade surface 15f-18f, 25f-28f of each respective barb 15-18, 25-28 is oriented generally facing the tapered surface of an adjacent barb, with an angle between the blade surface (e.g., at 17f, FIG. 1B) of each barb and an axis of the inner-surface (labeled z, FIG. 1B) being between 30 degrees and 60 degrees (with an angle of approx. 45 degrees, as depicted here, being quite suitable).

Alternatively, as best seen in FIGS. 3, 5A, 5C, and 6B, the barbs of the barbed-end may be arranged in a ‘tiered style’ such that each of the tapered surfaces 35t-38t (with an alternative configuration in phantom angled slightly, such as the tapered surface at 45t) is concentrically oriented along an axis (for reference, see FIGS. 3 and 5C at z) of the inner-surface, the length of sharp edge (not labeled, for simplicity) of each barb being respectively concentrically oriented along the axis. Each of the blade surfaces 35f-38f is generally ring-shaped and oriented genearlly radially orthogonal to the inner-surface. As depicted, blade surfaces 35f-38f are generally flat/planar in the radial x-y plane (plus or minus a few degrees, as shown) identified in FIG. 5B along φ (Greek symbol phi). An angle between the ring-shaped blade surface 35f and the tapered surface 36t of an adjacent barb is labeled a (Greek symbol alpha), and is preferably between 30 degrees and 60 degrees (with an angle of approx. 45 degrees, as shown, being quite suitable). By way of example, blade surfaces of an alternative set of barbs of the FIG. 5C embodiment may be slightly offset as depicted in phantom at 45f (with an associated tapered surface 45t of the end-barb labeled for reference). Once again, as can be seen in FIGS. 2A-2B, 3, 5A-5C the inner-surface of hollow 23b-23c is cylindrically shaped permitting the hollow to slidably-revolve around the stem upon application of a tangential-twisting force applied to handle 21.

In a further distinguishing characterization of the invention, the tool 20 depicted in FIGS. 2A-2C, 3, 5A-5C has two barbed-ends 22, 24, each one located a distance, respectively d₂, d₁, from a knurled handle 21. Referring also to FIGS. 6A-6B, removing flexible packing (such as that at 65a, 65b) in place around a stem (e.g., 62a, 62b) of a valve assembly (e.g., 61a, 61b) can be done with any of the barbed-end configurations depicted (e.g., 14, 22). The stem 62a, 62b is inserted into an end-port of the hollow extending within the tool—stated another way, the hollow of the tool is placed over the stem—and the stem is slid therealong until barbs 15-18, 25-28, 35-38 penetrate the flexible packing with at least a portion of a length of the sharp edge. Applying a tangential-twisting force (e.g., see directional arrow 50) to the handle 11, 21 slidably-revolves the hollow (e.g., 13, 23b-23c) around the stem, permitting a further penetration into the flexible packing such that a blade surface 15f-18f, 25f-28f, 35f-38f, 45f-48f of one or more barbs of the end (e.g., 14, 24, 22) contacts the flexible packing. Thereafter, applying an axial force to the handle (e.g., 11, 21) in a direction opposite to an initial force used during the step of inserting, and pulling the flexible packing in contact with the barb surfaces in the opposite direction along the stem, the packing may be removed. For the most part, upon application of this opposite force, the flexible packing is pulled out against respective generally flat/planar blade surfaces 15f-18f, 25f-28f, 35f-38f, and 45f (depending upon embodiment employed) as oriented, for removal from around the stem (e.g., 62a, 62b).

As can be better appreciated in connection with FIGS. 1A-1B, 2A-2B, 4, 5A-5B and 6A, barbed-end 14, 24 the application of tangential-twisting force (e.g., in the direction of arrow 50) to penetrate the flexible packing results in a generally simultaneous penetration of respective blade surfaces 15f-18f, 25f-28f into the flexible packing (e.g., 65a, FIG. 6A). Applying a tangential-twisting force to barbed-ends 14, 24 as configured, causes tapered surfaces 15t-18t, 25t-28t to also contact (penetrate) the flexible packing.

As can be better appreciated in connection with FIGS. 3, 5A, 5C, and 6B, for the ‘tiered-style’ barbed-end labeled 22, the application of a tangential-twisting force (either in direction 50, or—due to the symmetry of barbs 35-39—in a tangential-twisting directed opposite direction 50) results in penetrating the flexible packing (e.g., at 65b) of respective length(s) of sharp edge of the barbs in a sequential fashion, whereby the tapered surface 35t of the end-most barb 35 (though not specifically labeled as such) penetrates first, and thereafter penetration of the respective tapered surfaces (36t-38t) and blade surfaces (36f-38f) penetrate, sequentially into the flexible packing.

While certain representative embodiments and details have been shown for the purpose of illustrating the tool and method of the invention, those skilled in the art will readily appreciate that various modifications, whether specifically or expressly identified herein, may be made to any of the representative embodiments without departing from the novel core teachings or scope of this technical disclosure. Accordingly, such modifications are contemplated and intended to be included within the scope of the claims. Although the commonly employed preamble phrase “comprising the steps of” may be used herein in a method claim, applicants do not intend to invoke 35 U.S.C. §112 ¶6. Furthermore, in any claim that is filed herewith or hereafter, any means-plus-function clauses used, or later found to be present, are intended to cover at least all structure(s) described herein as performing the recited function and not only structural equivalents but also equivalent structures.

What is claimed is:

1. A handheld tool for removing flexible packing in place around the stem of a valve assembly, the tool comprising:
(a) an inner-surface defining a hollow extending within the tool and sized to accept the stem at an end-port of the hollow and to permit a sliding of the hollow along the stem;
(b) an integral handle having a grip surface around at least a portion of the hollow; and
(c) at one end of the tool and located a distance from the handle, is an integral barbed-end comprising a plurality of barbs, each barb having a length of sharp edge.

2. The tool of claim 1 wherein, for each of the barbs, the length of sharp edge is disposed between a tapered surface and a blade surface oriented generally orthogonal to the inner-surface of the hollow; the blade surface to contact the flexible packing for the removing thereof.

3. The tool of claim 2 wherein the tool is elongated in shape and further comprises, at a second end of the tool and located a second distance from the handle, an integral second barbed-end comprising a plurality of second barbs, each second barb having a length of sharp edge.

4. The tool of claim 2 wherein:
(a) each of the barbs is curve-tooth shaped and further comprises an outer curvilinear surface;
(b) along the distance from the handle to the one end, the tool has a cylindrical outer surface; and
(c) the plurality of curve-tooth shaped barbs are arranged around the one end such that the outer curvilinear surfaces are flush with the cylindrical outer surface.

5. The tool of claim 4 wherein the plurality of barbs are arranged such that each of the tapered surfaces taper inwardly toward the inner-surface, and a base of each curve-tooth shaped barb is generally equidistant around the cylindrical outer surface of the one end from the base of adjacent curve-tooth shaped barbs.

6. The tool of claim 4 wherein the blade surface of one of the plurality of barbs is oriented generally facing the tapered surface of an adjacent of the plurality of barbs, and an angle between the blade surface of each of the plurality of barbs and an axis of the inner-surface is between 30 degrees and 60 degrees.

7. The tool of claim 6 wherein:
(a) each of the blade surfaces is triangularly shaped having at least one curvilinear side;
(b) the angle is approximately 45 degrees; and
(c) the inner-surface is cylindrically shaped permitting the hollow to slidably-revolve around the stem upon application of a tangential-twisting force applied to the handle.

8. The tool of claim 2 wherein the plurality of barbs are arranged such that each of the tapered surfaces is concentrically oriented along an axis of the inner-surface, the length of sharp edge of each barb being respectively concentrically oriented along the axis.

9. The tool of claim 8 wherein an angle between the blade surface of one of the plurality of barbs and the tapered surface of an adjacent of the plurality of barbs, is between 30 degrees and 60 degrees.

10. The tool of claim 9 wherein:
(a) each of the blade surfaces is ring-shaped and oriented radially orthogonal to the inner-surface;
(b) the angle is approximately 45 degrees; and
(c) the inner-surface is cylindrically shaped permitting the hollow to slidably-revolve around the stem upon application of a tangential-twisting force applied to the handle.

11. The tool of claim 8 wherein:
(a) each of the blade surfaces is ring-shaped and oriented radially orthogonal to the inner-surface;
(b) the integral handle surrounds the hollow and the grip surface comprises a textured knurl; and
(c) upon the sliding of the hollow along the stem so that the lengths of sharp edge penetrate the flexible packing, a first and second of the blade surfaces contact the flexible packing.

12. A handheld tool for removing flexible packing in place around the stem of a valve assembly, the tool comprising:
(a) an inner-surface defining a hollow extending within the tool and sized to accept the stem and to permit a sliding of the hollow along the stem;
(b) an integral handle having a grip surface around at least a portion of the hollow;
(c) at one end of the tool and located a first distance from the handle, is an integral first barbed-end comprising a plurality of first barbs; and
(d) at a second end of the tool and located a second distance from the handle, is an integral second barbed-end comprising a plurality of second barbs.

13. The tool of claim 12 wherein:
(a) each of the first barbs further comprises a first length of sharp edge disposed between a first tapered surface and a first blade surface oriented generally orthogonal to the inner-surface of the hollow; and
(b) each of the second barbs further comprises a second length of sharp edge disposed between a second tapered surface and a second blade surface oriented generally orthogonal to the inner-surface of the hollow.

14. The tool of claim 13 wherein:
(a) each of the first barbs is curve-tooth shaped and further comprises an outer curvilinear surface; and the plurality of curve-tooth shaped barbs are arranged around the one end such that the outer curvilinear surfaces are flush with a cylindrical outer surface of the one end; and
(b) the plurality of second barbs are arranged such that each of the second tapered surfaces is concentrically oriented along an axis of the inner-surface, the second length of sharp edge of each barb being respectively concentrically oriented along the axis.

15. The tool of claim 13 wherein:
(a) each of the first barbs is curve-tooth shaped, and the first blade surface of one of the plurality of first barbs is oriented generally facing the first tapered surface of an adjacent of the plurality of first barbs, and an angle between the first blade surface of each of the plurality of first barbs and an axis of the inner-surface is between 30 degrees and 60 degrees; and
(b) the plurality of second barbs are arranged such that each of the second tapered surfaces is concentrically oriented along the axis of the inner-surface, and an angle between the second blade surface of one of the plurality of second barbs and the second tapered surface of an adjacent of the plurality of second barbs, is between 30 degrees and 60 degrees.

16. A handheld tool for removing flexible packing in place around the stem of a valve assembly, the tool comprising:
(a) an inner-surface defining a hollow extending within the tool and sized to accept the stem at an end-port of the hollow and to permit a sliding of the hollow along the stem;
(b) an integral handle having a grip surface around at least a portion of the hollow;
(c) at one end of the tool and located a distance from the handle, is an integral barbed-end comprising a plurality of curve-tooth shaped barbs, each barb having a length of sharp edge disposed between a tapered surface and a blade surface, and an outer curvilinear surface; and
(d) the plurality of curve-tooth shaped barbs being arranged around the one end such that the outer curvilinear surfaces are flush with a cylindrical outer surface of the one end.

17. A handheld tool for removing flexible packing in place around the stem of a valve assembly, the tool comprising:
(a) an inner-surface defining a hollow extending within the tool and sized to accept the stem at an end-port of the hollow and to permit a sliding of the hollow along the stem;
(b) an integral handle having a grip surface around at least a portion of the hollow;
(c) at one end of the tool and located a distance from the handle, is an integral barbed-end comprising a plurality of barbs, each barb having a length of sharp edge disposed between a tapered surface and a ring-shaped blade surface oriented radially orthogonal to the inner-surface; and
(d) an angle between the ring-shaped blade surface of one of the plurality of barbs and the tapered surface of an adjacent of the plurality of barbs, is between 30 degrees and 60 degrees.

18. A method for removing flexible packing in place around the stem of a valve assembly using a handheld tool, the method comprising the steps of:
(a) inserting the stem into an end-port of a hollow extending within the tool and sliding an inner-surface defining the hollow, along the stem;
(b) upon penetrating the flexible packing with at least a portion of a length of sharp edge of a first of a plurality of barbs of an integral barbed-end of the tool, applying a tangential-twisting force to an integral handle having a grip surface around at least a portion of the hollow, slidably-revolving the hollow around the stem, to further penetrate the flexible packing such that a blade surface of the first barb contacts the flexible packing; and
(c) applying an axial force to the integral handle in a direction opposite to an initial force used during the step of inserting, and pulling the flexible packing in contact with the first barb in the opposite direction along the stem for the removing.

19. The method of claim 18 wherein:
(a) the step of applying the tangential-twisting force further results in penetrating the flexible packing with each of a respective length of sharp edge of a second, third, and fourth of the barbs, such that a respective blade surface of each of the second, third, and fourth barbs also contact the flexible packing; and
(b) the step of pulling the flexible packing further comprises pulling flexible packing in contact with each of the respective blade surfaces.

20. The method of claim 19 wherein:
(a) each of the barbs is curve-tooth shaped and further comprises an outer curvilinear surface, the plurality of curve-tooth shaped barbs being arranged around the barbed-end such that the outer curvilinear surfaces are flush with a cylindrical outer surface of the barbed-end; and
(b) the step of penetrating the flexible packing with each of a respective length of sharp edge of the barbs further comprises a generally simultaneous penetration of the respective blade surfaces into the flexible packing.

21. The method of claim 18 wherein:
(a) the step of applying the tangential-twisting force further results in penetrating the flexible packing with each of a respective length of sharp edge of a second, third, and fourth of the barbs;
(b) the plurality of barbs are arranged such that each of the tapered surfaces is concentrically oriented along an axis of the inner-surface, the length of sharp edge of each barb being respectively concentrically oriented along the axis; and
(c) the step of penetrating the flexible packing with each of a respective length of sharp edge of the barbs further comprises a sequential penetration of the respective blade surfaces into the flexible packing.
